(19) United States
(12) Patent Application Publication
(10) Pub. No.: US 2011/0078237 A1
(43) Pub. Date: Mar. 31, 2011

(54) Server, network device, client, and network system

(75) Inventor: Nobuyuki Nakamura, Osaka (JP)

(73) Assignee: OKI ELECTRIC INDUSTRY CO., LTD., Tokyo (JP)

(21) Appl. No.: 12/923,139

(22) Filed: Sep. 3, 2010

(30) Foreign Application Priority Data
Sep. 30, 2009 (JP) 2009-226621

(51) Int. Cl. G06F 15/16; G06F 15/173

(52) U.S. Cl. 709/203; 709/238; 709/224

(57) ABSTRACT

A server in a network system generates packets including payload data and at least one capability field, and sends the packets on a traffic path in a communication network. The capability field may indicate the capability of the server to provide the payload data, as determined by the server itself, or the capability of the traffic path to transfer the packets. In the latter case, network devices that transfer the packets update the capability field, or add a new capability field reporting their individual packet transfer capability. A client device receiving the packets can use the information in the capability field(s) to isolate quality problems to the server or the communication network, or to specific network devices in the communication network, and take appropriate action such as canceling a service request or reducing the requested level of service.

### BACKGROUND OF THE INVENTION

1. Field of the Invention

The present invention relates to a server, a network device, a client device, and a network system.

2. Description of the Related Art

The real-time streaming technology used to transmit telephone calls and distribute music over the Internet in recent years is now being actively extended to support video distribution services. A number of streaming protocols are in use, including the Real-time Transport Protocol (RTP), the RTP Control Protocol (RTCP), and the RTP Control Protocol Extended Reports (RTCP-XR). In the RTCP and RTCP-XR protocols, for example, a data transmitting party (server) and a data receiving party (client) exchange messages to reporting the quality of service that the server is providing and the client is receiving. The server accordingly sends RTP data packets and RTCP report packets to the client, and the client sends RTCP report packets to the server. This enables telecommunications carriers providing Internet Protocol telephony (IP phone) and other services to confirm that their services are being provided with at least a predetermined quality level. Detailed specifications can be found in Network Working Group Requests for Comments (RFC) 3550 and 3661.

A variation of this scheme is disclosed by Miyamoto in Japanese Patent Application Publication No. 2009-94877. In this variation, also based on the RFC 3550 and 3661 protocols, when a network device at an intermediate node in the network transfers RTP data packets from a server to a client, it also measures communication quality parameters from information provided in the packet headers. When the client sends a report packet to the server, the network device may replace the communication parameters in the report with the communication parameters the network device has measured itself. When quality of service deteriorates, the measurements carried out at different network nodes help service providers to identify the node on the network at which the quality of service is being degraded.

The report information in RTCP, RTCP-XR, and other such communication protocols pertains only to RTP traffic, that is, to real-time data streams. The techniques disclosed in RFC 3550 and 3661 and by Miyamoto are therefore useful in IP networks directed primarily toward telephony, such as the so-called next generation networks (NGNs), but in IP networks such as the Internet and other internets that incorporate a wide variety of different types of servers providing various types of service to various clients, network performance is not considered in most applications. The information supplied in these reports is useful for evaluating RTP traffic performance in best-effort environments, but has no further value to the IP network.

There is a need for a network system that can provide a quality reporting protocol that covers all traffic, so that all applications can obtain information about the quality of service available to them, and all types of service can be improved.

### SUMMARY OF THE INVENTION

An object of the present invention is to enable a client device that receives any type of service from a server through a communication network to obtain information indicating the quality of service that can be provided.

Another object is to enable the client device to determine whether a failure to obtain a desired quality of service is due to a problem at the server or a problem in the communication network.

A further object is to improve the management and maintenance of the communication network.

The invention provides a server connected to a communication network. The server includes a service providing unit that generates payload data, and a network interface unit that generates a packet including the payload data and a capability field. The network interface unit sends the packet to the communication network to be transmitted on a traffic path toward a destination. The payload data may be service data supplied to provide a requested service, or a probe response generated in reply to a probe packet received by the server. The capability field may indicate the capability of the service providing unit to provide the payload data, as determined by a service providing capability measuring unit in the server, or the capability of the traffic path to transfer the packet, as determined by network devices on the traffic path. The packet may include capability fields of both of these types.

The invention also provides a network device connected to the server through the communication network. The network device includes a network interface unit that receives the packet sent by the server, a transfer processing unit that determines the next destination of the packet on the traffic path, and a transfer capability measuring unit that determines the packet transfer capability of the network device. The network interface unit sends the received packet to the next destination determined by the transfer processing unit, using the value calculated by the transfer capability measuring unit to update the value in the packet transfer capability field of the packet, or to add a new packet transfer capability field to the packet. A newly added packet transfer capability field may include identifying information identifying the network device that added the new field.

The invention also provides a client device connected to the communication network to receive the packet sent by the server. The client device includes an application unit that processes the payload data in the packet, and a quality processing unit that processes the capability field(s) to obtain quality information and provides the quality information to the application unit. When the quality information indicates that a prescribed quality of service cannot be obtained, the application unit takes action such as canceling the service or reducing a requested level of the service.

The invention also provides a network system including a server and a network device as described above, a server and a client device as described above, or a server, a network device, and a client device as described above.

The capability field or fields in a received packet enable the client device to determine whether a quality problem is due to a problem in the server or a problem in the communication network. If the each network device that transfers the packet adds a new packet transfer capability field including information identifying the network device, the client can isolate network problems to specific network devices and thereby provide information useful in network management and maintenance.

Since the capability fields can be attached to all data packets, the information they provide is available to all applications operating on client devices and other devices connected to the communication network.

### BRIEF DESCRIPTION OF THE DRAWINGS

In the attached drawings:

FIG. 1 schematically illustrates a network system used as an example in first to third embodiments of the invention, and the contents of two data packets transferred from servers to a client device in the network system on respective traffic paths;

FIG. 2 schematically illustrates the internal structure of either or both of the servers in FIG. 1 and the contents of a data packet sent by the server;

FIG. 3 schematically illustrates the internal structure of a network device in the network system and the contents of a data packet transferred by the network device;

FIG. 4 schematically illustrates the internal structure of the client device in FIG. 1 and the contents of a data packet received by the client device;

FIG. 5 is a sequence diagram illustrating the operation of the network system in the first embodiment;

FIG. 6 schematically illustrates the internal structure of a server in the second embodiment of the invention;

FIG. 7 schematically illustrates the internal structure of a network device in the second embodiment;

FIG. 8 schematically illustrates the internal structure of a client device in the second embodiment;

FIG. 9 is a sequence diagram illustrating the operation of the network system in the second embodiment;

FIG. 10 schematically illustrates the internal structure of a server in the third embodiment of the invention;

FIG. 11 illustrates the data structure of a data packet generated by the server in the third embodiment;

FIG. 12 schematically illustrates the internal structure of a network device in the third embodiment;

FIG. 13 schematically illustrates the internal structure of a client device in the third embodiment; and

FIG. 14 illustrates the data structure of a data packet generated by the server in a variation of the third embodiment.

### DETAILED DESCRIPTION OF THE INVENTION

Embodiments of the invention will now be described with reference to the attached drawings, in which like elements are indicated by like reference characters.

The packets illustrated in the drawings have headers including source and destination addresses, port numbers, checksums, and other well known information. For simplicity, the headers are not shown in most of the drawings.

Each of the servers, network devices, and client devices shown in the drawings includes a central processing unit (CPU) and various peripheral units such as memory and input/output (I/O) units, the latter typically including a display screen and a disk storage unit. A network device includes a queue buffer as part of its memory. These well-known hardware units will be mentioned in the description but, for simplicity, are omitted from the drawings. The units shown in the drawings typically include a combination of parts of the above hardware together with software stored in the memory or the disk storage unit.

The term ‘application’ as used herein includes but is not limited to the meaning of ‘application software’.

### First Embodiment

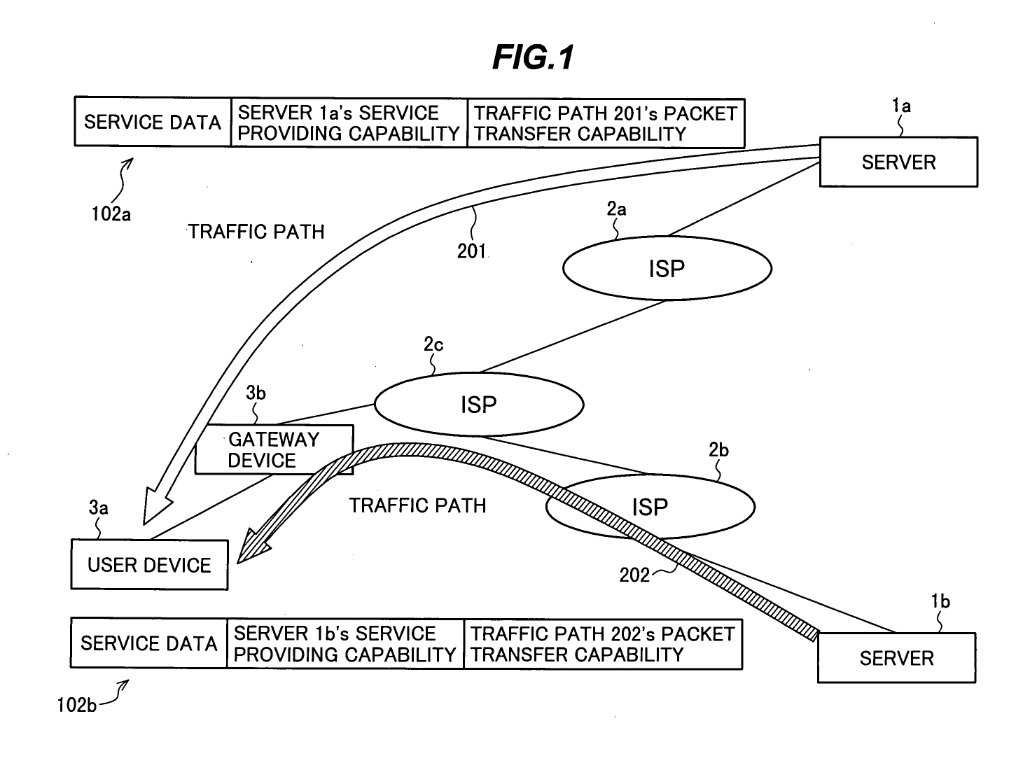

Referring to FIG. 1, the network system in the first embodiment includes a server 1a connected to an Internet service provider (ISP) 2a, another server 1b connected to another ISP 2b, and a user device 3a connected through a gateway device 3b to a third ISP 2c, which is connected to both of the first two ISPs 2a, 2b.

It will be appreciated that FIG. 1 shows only one exemplary configuration, and that other configurations with different numbers of servers, ISPs, gateway devices, and user devices are also possible.

In FIG. 1, a data packet 102a is transported on a traffic path 201 from server 1a through network devices 2a, 2c and gateway device 3b to the user device 3a. Another data packet 102b is transported on another traffic path 202 from server 1b through network devices 2b, 2c and gateway device 3b to the user device 3a. The contents of these data packets 102a, 102b will be described in more detail later.

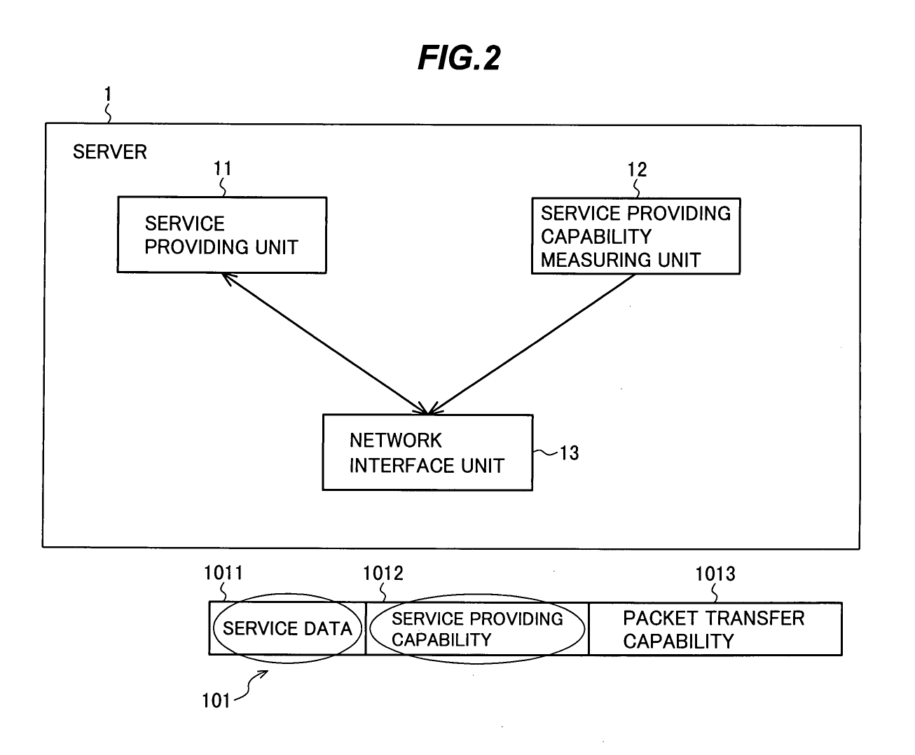

FIG. 2 shows the generic internal configuration of a server 1 in the first embodiment. The server 1 includes at least a service providing unit 11, a service providing capability measuring unit 12, and a network interface unit 13. The network interface unit 13 is connected to the service providing unit 11 and service providing capability measuring unit 12 and communicates with the network to which the server 1 is connected. At least one of the servers 1a, 1b in FIG. 1 has the internal structure shown in FIG. 2. The network system may include any number of servers with this internal structure, as well as servers with other internal structures.

The service providing unit 11 in FIG. 2 carries out the usual server function of providing a service, making use of the server's a CPU, memory, and I/O resources (not shown), and thereby generating service data 1011, which it sends to the network interface unit 13.

The service providing capability measuring unit 12 measures the instantaneous activity of the server's CPU, its memory usage, the CPU occupancy rates and memory allocations of application programs running on the server 1, the rate at which I/O interrupts occur, the current usage of the network interface unit 13, and other such current or instantaneous values, calculates a service providing capability value 1012, and sends this value to the network interface unit 13.

In a variation of the first embodiment, instead of measuring current or instantaneous values, the service providing capability measuring unit 12 measures mean values over a period of time, and may also measure the variance or standard deviation of the current or instantaneous values.

The network interface unit 13 generates a data packet 101 by appending two fields to the service data 1011 received from the service providing unit 11: one field for the service providing capability value 1012; the other for a packet transfer capability value 1013. The network interface unit 13 also generates and adds a packet header (not shown). The network interface unit 13 writes the service providing capability value 1012 received from the service providing capability measuring unit 12 in the service providing capability field, writes a prescribed initial value in the packet transfer capability field, calculates the checksum (not shown) from the service data 1011, service providing capability value 1012, and packet transfer capability value 1013 and part of the packet header information (not shown), and sends the data packet 101 toward a client device 3, described below.

In the following description, for simplicity, reference numerals 1012 and 1013 will be used both to denote the respective capability values and the fields in which these values are placed.

The service data 1011 are the payload data of the data packet 101, that is, the data to be delivered to the final destination of the packet.

Both of the packets 102a, 102b shown in FIG. 1 have the same configuration as the data packet 101 in FIG. 2.

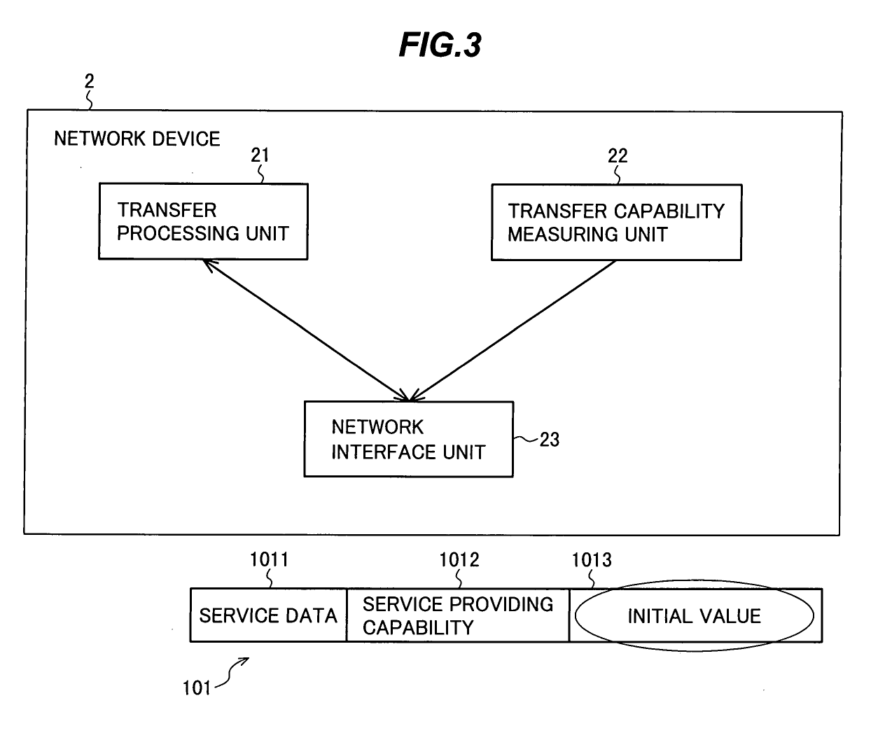

FIG. 3 shows the generic internal configuration of a network device 2 such as a switch or router that relays data in the network system in the first embodiment. The network device 2 includes at least a transfer processing unit 21, a transfer capability measuring unit 22, and a network interface unit 23. The network interface unit 23 is connected to the transfer processing unit 21 and transfer capability measuring unit 22 and communicates with the network to which the network device 2 is connected.

When the network interface unit 23 receives a data packet 101, the transfer processing unit 21 examines the packet header, decides from a table such as a routing table or an address resolution protocol (ARP) table where the data packet 101 should be sent next, and passes the data packet 101 back to the network interface unit 23 to be output from the appropriate port.

When the network device 2 relays a data packet, the transfer capability measuring unit 22 measures various current or instantaneous information such as the instantaneous CPU load of the network device 2, the amount of data currently queued in its queue buffer, the current packet transfer time or its variance, the current load on the network interface unit 23, the current packet loss rate on the link connected to the network port, the propagation delay to calculate a value indicating a degradation of quality due to the network device 2 itself, and supplies this value to the network interface unit 23 for use in updating the packet transfer capability field 1013.

In a variation of the first embodiment, instead of measuring current or instantaneous values, the transfer capability measuring unit 22 measures mean values over a period of time, and may also measure the variance or standard deviation of the current or instantaneous values.

When the network interface unit 23 receives a data packet 101 from the transfer processing unit 21, it determines whether a packet transfer capability value 1013 has been set in the corresponding field, and if so, updates the packet transfer capability value 1013 by subtracting the quality degradation value supplied by the transfer capability measuring unit 22. Since this update changes the content of the packet, the network interface unit 23 also recalculates the checksum (not shown) in the packet header. The network interface unit 23 then sends the data packet 101 onward toward the client device 3.

The network system normally includes a plurality of network devices with the internal structure shown in FIG. 3. All three of the ISPs 2a, 2b, 2c shown in FIG. 1 may include network devices with this internal structure, for example. The number of network devices with this structure is not limited.

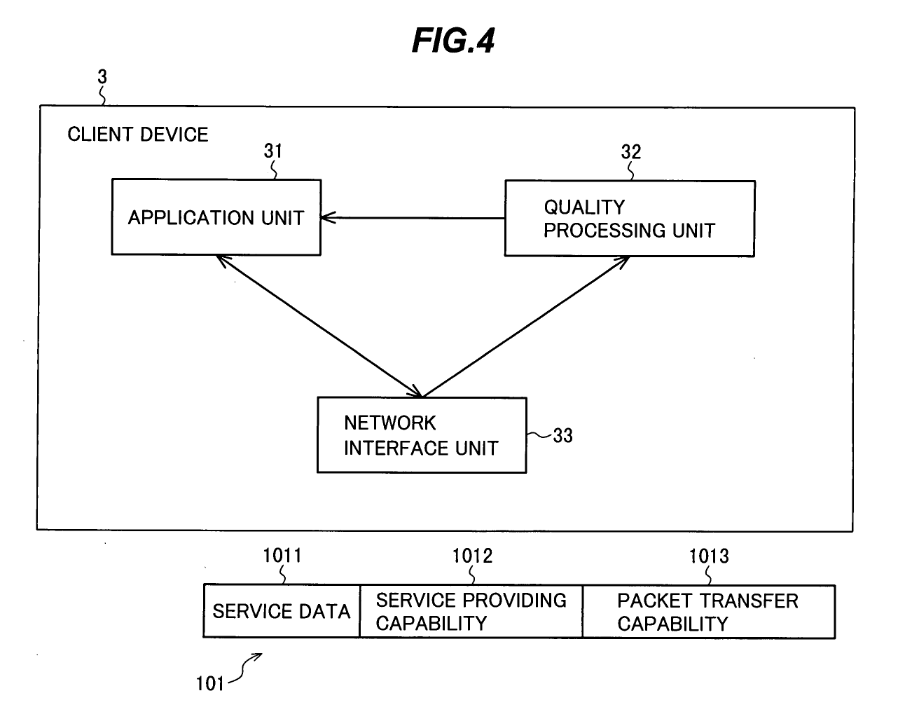

The generic internal structure of the client device 3 referred to above is shown in FIG. 4. The user device 3a in FIG. 1 has this internal structure. The gateway device 3b in FIG. 1 may also have this internal structure. The network system may include any number of client devices 3 with this internal structure.

As FIG. 4 shows, the client device 3 includes an application unit 31, a quality processing unit 32 connected to the application unit 31, and a network interface unit 33, connected to the application unit 31 and quality processing unit 32. The network interface unit 33 communicates with the network to which the client device 3 is connected.

The application unit 31 sends service request packets through the network interface unit 33 to a server 1, and receives the service provided by the server 1. The application unit 31 also receives quality information from the quality processing unit 32 and takes appropriate action. The appropriate action is taken when a preset quality value is not attained. Various actions may be taken, such as displaying a ‘Service Unavailable’ message on a liquid crystal display (LCD) screen of the client device 3 and canceling data transfer, or displaying a message offering the user of the client device 3a a choice of canceling the data transfer or continuing at a reduced service level. The application unit 31 may include the operating system (OS) of the client device 3.

The quality processing unit 32 receives the contents of the service providing capability field 1012 and packet transfer capability field 1013 of each received data packet 101 from the network interface unit 33, and provides the application unit 31 with quality information including the service providing capability of the server 1 that sent the data packet 101 and the packet transfer capability of the traffic path by which the data packet 101 was received.

The network interface unit 33 sends service request packets supplied by the application unit 31 to the appropriate server 1, verifies data packets 101 received from the server 1 in reply by repeating the checksum calculation and comparing the result with the checksum (not shown) in the packet header, and passes data packets 101 to the application unit 31 if they pass this check. More specifically, the network interface unit 33 passes the service data 1011 of the data packet 101 to the application unit 31. If a received data packet 101 has a value set in its service providing capability field 1012 and/or packet transfer capability field 1013, the network interface unit 33 passes those value(s) to the quality processing unit 32.

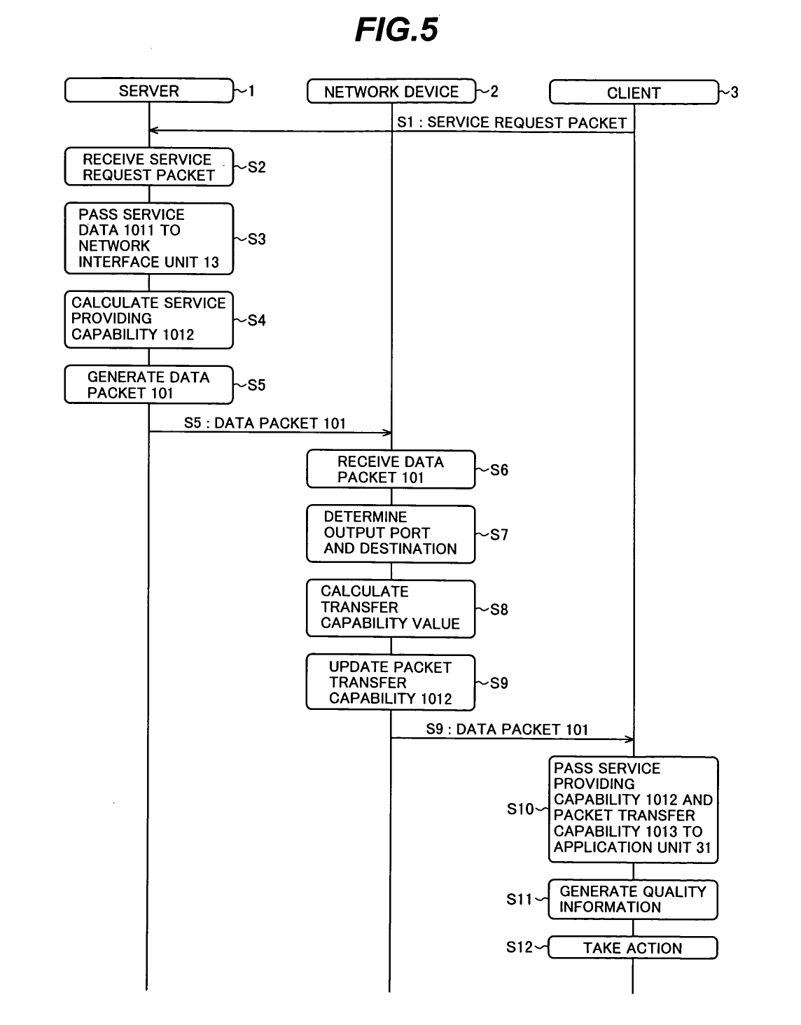

The operation of the network system in the first embodiment will now be described with reference to FIG. 5. The client device 3 in this description is a user device such as the user device 3a in FIG. 1.

In step S1, the application unit 31 in the client device 3 sends a service request packet through the client device's network interface unit 33 to a server 1 to request a desired service from the server 1.

In the next step S2, the service providing unit 11 of the server 1 receives the service request packet through the network interface unit 13.

In the next step S3, the service providing unit 11 generates service data 1011 to be provided to the client device 3, and passes the service data 1011 to the network interface unit 13.

In the next step S4, the service providing capability measuring unit 12 calculates the server's service providing capability 1012 as described above, and passes a value representing this capability to the network interface unit 13. If, for example, only 60% or less of the processing capability of the CPU of the server 1 is currently being utilized and least 20% of its memory space is free, indicating that the server 1 has adequate resources for application operations, and if disk I/O interrupts and other interrupts are not occurring too frequently and usage of the network interface unit 13 is sufficiently light, the network interface unit 13 may assign a value of one hundred (100) to the service providing capability field 1012, smaller values being assigned as CPU activity, interrupts, and network interface usage increase and free memory space decreases.

Although steps S3 and S4 are shown as taking place sequentially, they may be carried out concurrently.

In the next step S5, the network interface unit 13 assembles a data packet 101 by appending the service providing capability value 1012 supplied by the service providing capability measuring unit 12 and an initial packet transfer capability value 1013 (e.g., a value of 100) to the service data 1011 supplied by the service providing unit 11 and calculating a checksum, and sends the data packet 101 onto the network, addressed to the client device 3.

In the next step S6, the data packet 101 is received by the network interface unit 23 of a network device 2, and passed to the transfer processing unit 21 of the network device 2.

In the next step S7, the transfer processing unit 21 determines the destination of the data packet 101 on the next hop of its traffic path toward the client device 3 and the port from which the data packet should be transmitted to this next destination, and passes the data packet back to the network interface unit 23.

In the next step S8, the transfer capability measuring unit 22 calculates the network device's packet transfer capability value 1013 as described above, and passes this value to the network interface unit 23. If, for example, only 60% or less of the processing capability of the CPU of the network device 2 is currently being utilized and its queue buffer is less than 5% full, and the network interface unit 23 is less than 20% loaded, the network interface unit 23 may set a value of zero (0) in the packet transfer capability field 1013, larger values being set as CPU utilization, queue buffer utilization, and network interface utilization increase.

Although steps S7 and S8 are shown as taking place sequentially, they may be carried out concurrently.

In the next step S9, the network interface unit 23 updates the packet transfer capability field 1013 of the data packet 101 by subtracting the value supplied by the transfer capability measuring unit 22, recalculates the checksum, and sends the packet on the next hop of its traffic path toward the client device 3. Steps S6 to S9 are repeated at each network device on this traffic path, the value in the packet transfer capability field 1013 gradually diminishing as the data packet 101 traverses the traffic path.

In the next step S10, the network interface unit 33 of the client device 3 receives the data packet 101 from the last network device 2 on the traffic path and verifies its checksum as described above. If the checksum is correct, the network interface unit 33 passes the service providing capability value 1012 and packet transfer capability value 1013 (if present) to the quality processing unit 32, and passes the service data 1011 to the application unit 31. The application unit 31 processes the service data 1011 in the normal manner, unless there is an interrupt from the quality processing unit 32.

In the next step S11, the quality processing unit 32 generates quality information from the service providing capability value 1012 and packet transfer capability value 1013, and generates an interrupt if the service providing capability value 1012 or packet transfer capability value 1013, or a value calculated therefrom, fails to attain a predetermined value. This interrupt triggers the next step S12.

In step S12, the application unit 31 receives the quality information from the quality processing unit 32 and takes appropriate action as described above.

When the server 1 is unable to obtain requested service from the server 1, the quality information provided by the quality processing unit 32 enables the application unit 31 to determine whether the fault lies with the server 1 itself or with the network. When the fault lies with the network, client devices 3 that have issued non-urgent service requests and find themselves receiving inferior service can cancel their service requests, thereby relieving traffic congestion on the network and enabling other clients to obtain an adequate level of service.

This effect is achieved simply by appending fields for the service providing capability value 1012 and packet transfer capability value 1013 to data packets generated by the server 1, without requiring the generation and transmission of separate quality measurement report packets.

In a variation of the first embodiment, the packet transfer capability field 1013 is added by a network device 2 instead of by the server 1. When the network device 2 receives a data packet lacking a packet transfer capability field 1013, the network interface unit 23 calculates a packet transfer capability value 1013 by, for example, subtracting the value supplied by the transfer capability measuring unit 22 from a predefined initial value, appends the calculated packet transfer capability value 1013 to the data packet, and sends the data packet with the appended packet transfer capability value 1013 to the next network device or the client device 3.

In another variation of the first embodiment, the server 1 adds a service providing capability field 1012 and a packet transfer capability field 1013 to, for example, every Nth data packet, where N is an integer greater than one, instead of adding these fields 1012, 1013 to every data packet.

In another variation of the first embodiment, the server 1 adds only a service providing capability field 1012 or only a packet transfer capability field 1013, instead of both a service providing capability field 1012 and a packet transfer capability field 1013, to the data packets, and the application unit 31 in the client device 3 takes action based only on the service providing capability value 1012 or only on the packet transfer capability value 1013.

In another variation of the first embodiment, the service providing capability value 1012 and packet transfer capability value 1013 are received and processed by, for example, the gateway device 3b in FIG. 1 instead of the user device 3a, and the gateway device 3b takes appropriate action when the necessary quality of service is not obtained.

### Second Embodiment

Whereas the first embodiment only enables the server or the network as a whole to be identified as being responsible for a quality of service problem, the second embodiment enables responsibility to be traced to individual network devices.

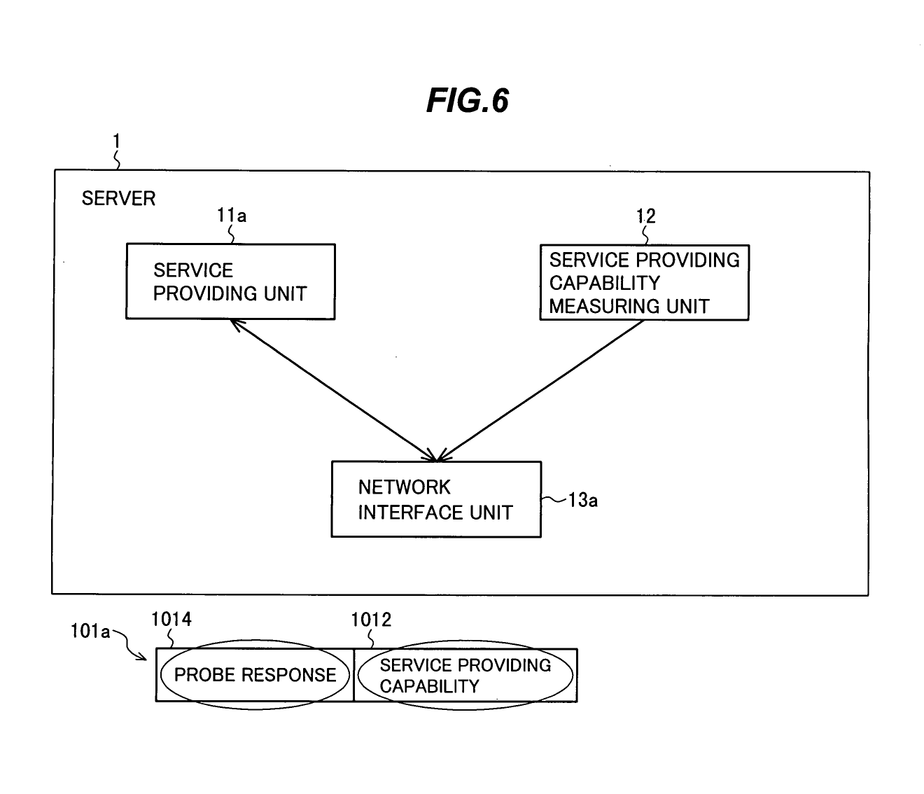

Referring to FIG. 6, the server 1 in the second embodiment includes a service providing unit 11a, a service providing capability measuring unit 12, and a network interface unit 13a generally similar to the corresponding elements in the first embodiment and similarly interconnected.

The service providing capability measuring unit 12 operates as described in the first embodiment. The service providing unit 11a operates as described in the first embodiment in generating data packets, and also generates probe responses 1014 in reply to probe packets received from a client device 3.

The network interface unit 13a operates as described in the first embodiment in receiving service request packets and sending data packets, and also receives probe packets, passes each received probe packet to the service providing unit 11a, receives a probe response 1014 from the service providing unit 11a, appends the service providing capability value 1012 supplied by the service providing capability measuring unit 12 to the probe response 1014 and adds a packet header (not shown) to generate a data packet 101a, and sends the data packet 101a on a traffic path leading to the client device 3. The probe response 1014 is the payload data of the data packet 101a.

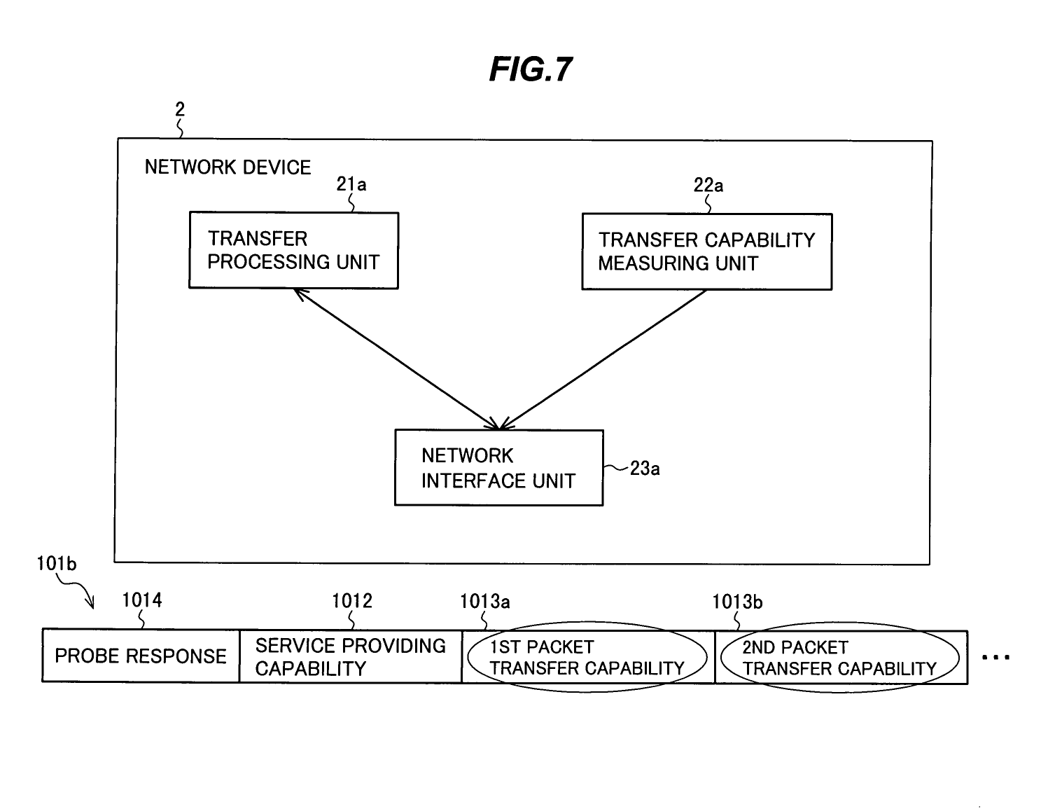

Referring to FIG. 7, the network device 2 in the second embodiment includes a transfer processing unit 21a, a transfer capability measuring unit 22a, and a network interface 23a, generally similar to the corresponding elements in the first embodiment and similarly interconnected.

The transfer processing unit 21a processes both data packets 101 including service data and the data packets 101a including probe responses 1014 in the same way, by selecting the next destination of the packet on its traffic path and supplying the necessary address and port information to the network interface 23a, as described in the first embodiment.

The transfer capability measuring unit 22a operates in the same way as the transfer capability measuring unit 22 in the first embodiment, except that it calculates packet transfer capability values when both types of data packets 101, 101a are received.

The network interface 23a operates in the same way as the transfer capability measuring unit 22 in the first embodiment, except that when sending a data packet including a probe response 1014, instead of updating the packet transfer capability value, it generates a first packet transfer capability field 1013a by adding identifying information such as the Internet Protocol (IP) address of the network device 2 to the value supplied by the transfer capability measuring unit 22a, appends the first packet transfer capability field 1013a to the data packet 101a, recalculates the checksum (not shown), and sends the resulting data packet 101b, including the probe response 1014, service providing capability value 1012, and first packet transfer capability value 1013a, toward the client device 3.

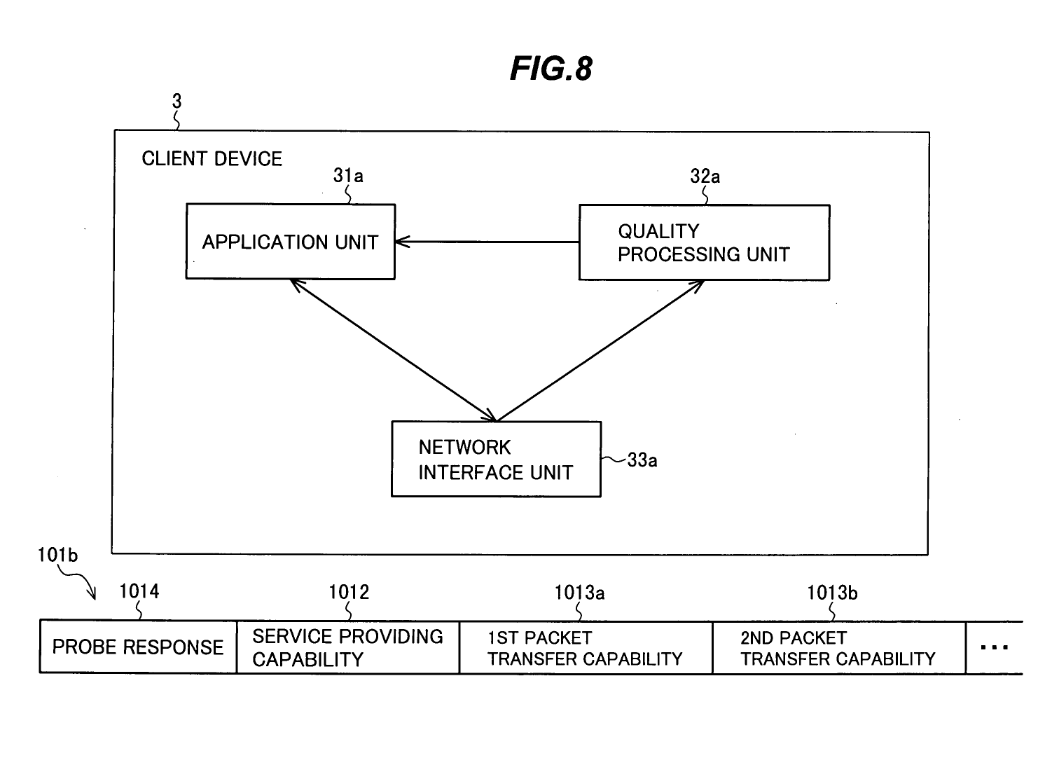

Referring to FIG. 8, the client device 3 in the second embodiment includes an application unit 31a, a quality processing unit 32a, and a network interface unit 33a, generally similar to the corresponding elements in the first embodiment and similarly interconnected.

The application unit 31a performs the operations described in the first embodiment. In addition, when notified of inadequate service quality by the quality processing unit 32a or by the user of the client device 3, or when the application unit 31a itself detects inadequate service quality, the application unit 31a generates a probe packet, and sends the probe packet through the network interface unit 33a to the server 1 that provided the inadequate service. Furthermore, the appropriate action taken by the application unit 31a in response to quality information received from the 32a may include action directed toward a specific network device, such as sending a report to the relevant internet service provider.

The quality processing unit 32a operates as described in the first embodiment in generating quality information from the service providing capability value 1012 and packet transfer capability value 1013 included in an ordinary data packet 101. In addition, when provided with a data packet 101b including a probe response 1014, the quality processing unit 32a generates more detailed quality information including, for example, the identifiers of specific network devices that are causing packet transfer problems, and sends this more detailed quality information to the application unit 31a.

The network interface unit 33a operates as described in the first embodiment, except that when it receives a data packet 101b including a probe response 1014, it passes the entire data packet 101b to the quality processing unit 32a and, if necessary, to the application unit 31a.

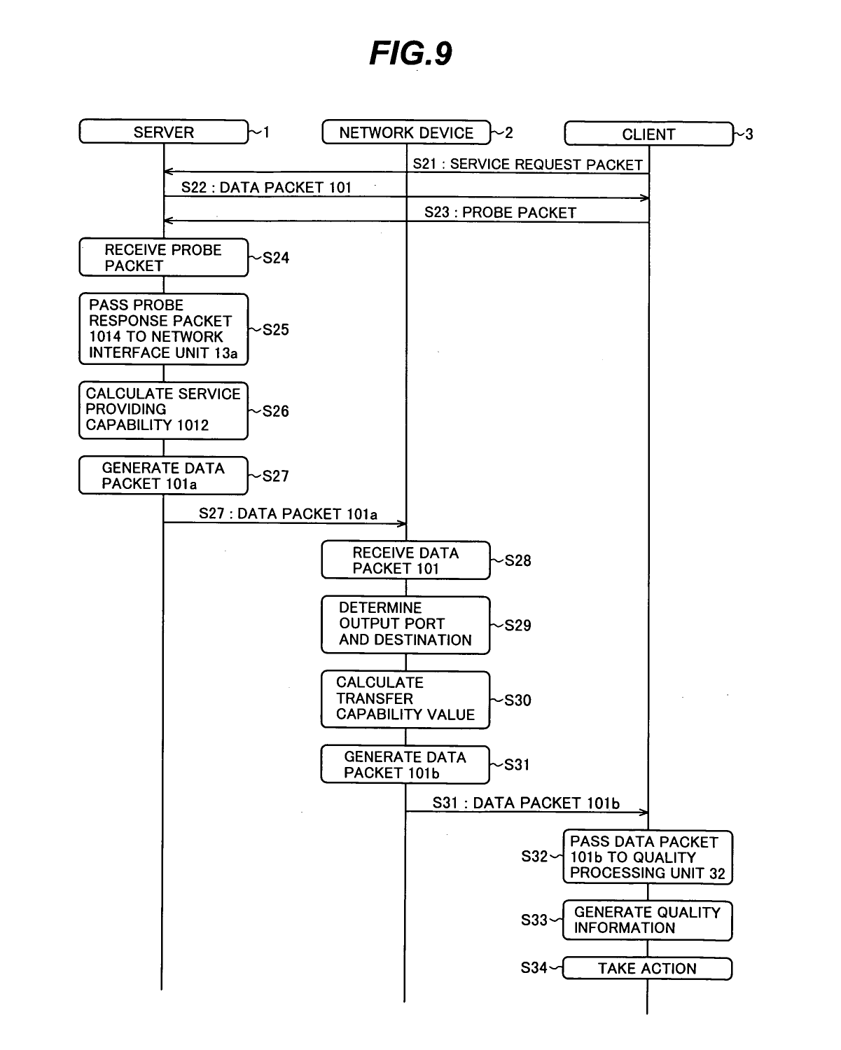

The operation of the network system in the second embodiment will now be described with reference to FIG. 9.

In step S21, the application unit 31a in the client device 3 sends a service request packet through the network interface unit 33a to the server 1 to request a desired service from the server 1.

In the next step S22, the server 1 replies to the service request packet by sending a data packet 101 to the client device 3 as described in the first embodiment.

In the next step S23, a deficiency in the quality of service is detected at the client device 3, either by the quality processing unit 32a as described in the first embodiment, or by the application unit 31a or the user of the client device 3, and the application unit 31a sends the server 1 a probe packet through the network interface unit 33a to investigate the cause of the problem.

In the next step S24, the application unit 31a at the server 1 receives the probe packet through the network interface unit 33a.

In the next step S25, the application unit 31a generates a corresponding probe response 1014 and supplies it to the network interface unit 13a.

In the next step S26, the service providing capability measuring unit 12 calculates the server's service providing capability 1012 as described in the first embodiment, and passes this value to the network interface unit 13a. Steps S25 and S26 may be carried out concurrently.

In the next step S27, the network interface unit 13 assembles a data packet 101a by appending the service providing capability value 1012 supplied by the service providing capability measuring unit 12 to the probe response 1014 supplied by the service providing unit 11, and sends the data packet 101a onto the network, addressed to the client device 3.

In the next step S28, the data packet 101a is received by the network interface 23a of a network device 2, and passed to the transfer processing unit 21a of the network device 2.

In the next step S29, the transfer processing unit 21a determines the destination of the data packet 101a on its next hop toward the client device 3 and the port from which it should be transmitted on this next hop, and passes the data packet 101a back to the network interface 23a.

In the next step S30, the transfer capability measuring unit 22a calculates the network device's packet transfer capability as described in the first embodiment and passes this value to the network interface 23a. Steps S29 and S30 may be carried out concurrently.

In the next step S31, the network interface 23a generates a first packet transfer capability field 1013a by adding identifying information to the value supplied by the transfer capability measuring unit 22a, appends the first packet transfer capability field 1013a to the data packet 101a, and sends the resulting data packet 101b on its next hop toward the client device 3.

Steps S28 to S31 are repeated at each network device 2 on the traffic path to the user device 3. At the next network device 2, the data packet 101b acquires a second packet transfer capability field 1013b, which is appended behind the first packet transfer capability field 1013a as shown in FIG. 7. At further hops, the data packet 101b acquires further packet transfer capability fields, each including the identifier of the network device 2 by which it was added.

In the next step S32, the network interface unit 33 of the client device 3 receives the data packet 101b from the last network device 2 on the traffic path, and passes the data packet 101b to the quality processing unit 32a. The data packet 101b may also be passed to the application unit 31a if necessary.

In the next step S33, the quality processing unit 32a analyzes the service providing capability field 1012 and packet transfer capability fields 1013a, 1013b, . . . included in the data packet 101b according to threshold values or the like to derive quality information indicating the source of the service quality problem, and passes this quality information to the application unit 31a. For example, if the service providing capability value 1012 is below a first threshold, the quality information indicates that the service providing capability of the server 1 is inadequate; if the first packet transfer capability value 1013a, the second packet transfer capability value 1013b, or another packet transfer capability value is below a second threshold value, the quality information indicates that the packet transfer capability of the network device 2 identified by the identifying information attached to the particular packet transfer capability value is inadequate. If any inadequacy is found, the quality processing unit 32a generates an interrupt to notify the application unit 31a, triggering the next step S34.

In the step S34, the application unit 31a receives the quality information from the quality processing unit 32a and takes appropriate action as described above.

By attaching a string of packet transfer capability fields to data packets 101b sent in response to probe packets, the second embodiment provides more detailed information than the first embodiment as to the specific locations of network problems. Because this more detailed information is available, there is less need for the information provided by the service providing capability and packet transfer capability values added to service data packets 101, so this information may be added less frequently than in the first embodiment, thereby using network bandwidth resources more efficiently.

By allowing the client device 3 to provide information about specific network devices 2 to internet service providers or other network administrators, the second embodiment can contribute to the improvement of overall network management. This information can be used, for example, to identify overloaded or malfunctioning network devices, so that they can be replaced or repaired.

In a variation of the second embodiment, instead of sending probe packets when specific service quality problems are recognized, the client device 3 sends probe packets at regular intervals, or when general network quality problems are recognized.

In another variation of the second embodiment, data packets including probe responses are processed in the same way as service data packets, by updating the packet transfer capability field at each network device 2 by subtracting a value supplied by the transfer capability measuring unit 22a, instead of appending a new packet transfer capability field at each network device.

Conversely, service data may be processed in the same way as data packets including probe responses, by appending a new packet transfer capability field at each network device 2, instead of by updating the packet transfer capability field at each network device 2 by subtracting a value supplied by the transfer capability measuring unit 22a.

In another variation of the second embodiment, only a service providing capability or only a packet transfer capability field, instead of both a service providing capability and a packet transfer capability field, are added to data packets including probe responses, and the application unit 31 in the client device 3 takes action based only on the service providing capability value 1012 or only on the packet transfer capability value 1013.

### Third Embodiment

The third embodiment restricts the range of coverage of the checksum in the first or second embodiment.

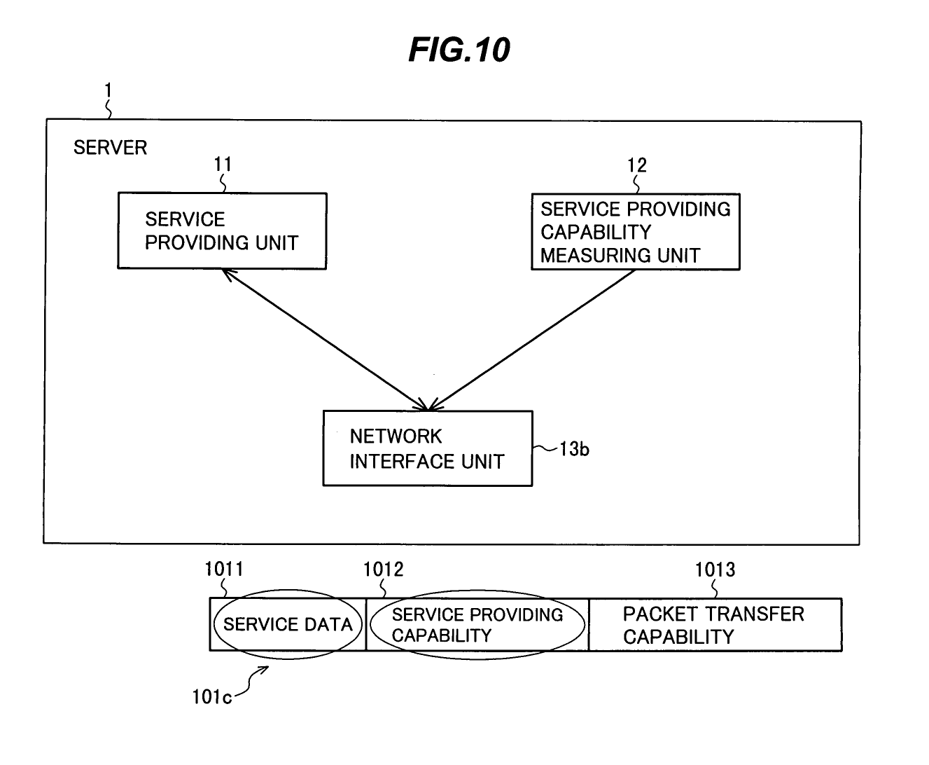

Referring to FIG. 10, the server 1 in the third embodiment includes at least a service providing unit 11, a service providing capability measuring unit 12, and a network interface unit 13b that are generally similar to the corresponding elements in the first embodiment and are similarly interconnected.

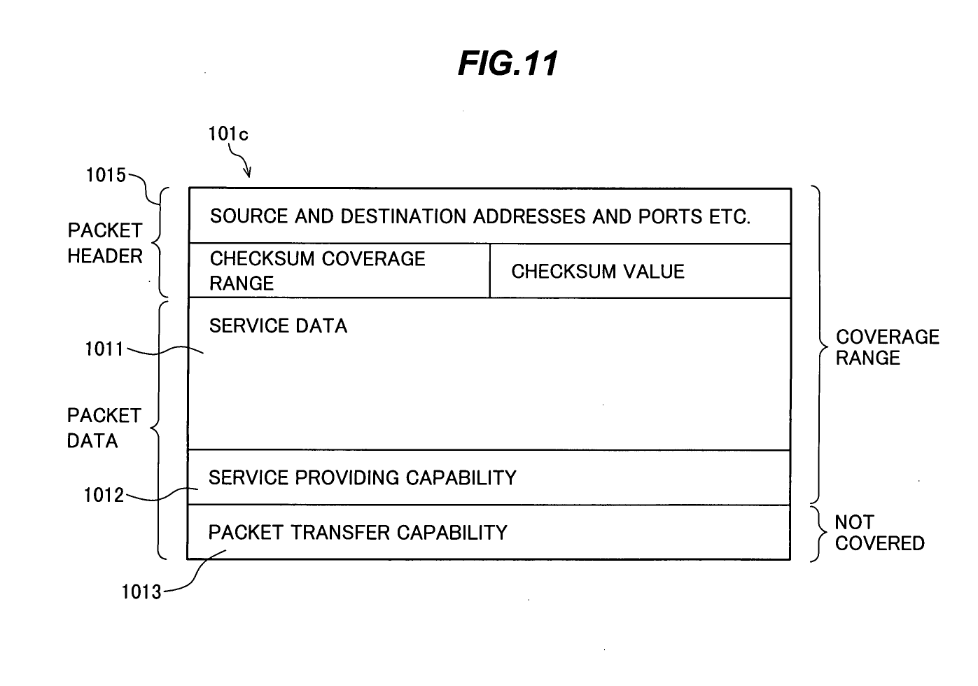

The service providing unit 11 and service providing capability measuring unit 12 operate as described in the first embodiment. The network interface unit 13b operates as described in the first embodiment in generating a data packet by adding a service providing capability field 1012 and a packet transfer capability field 1013 to service data 1011 provided by the service providing unit 11, but adds a packet header, differing from the packet header added in the first embodiment, to the resulting data packet 101c. Referring to FIG. 11, the packet header 1015 in the third embodiment includes address and port information and a checksum value as mentioned in the first embodiment, but also includes a checksum coverage range field indicating that the checksum value has been calculated only from the information in the packet header 1015, the service data 1011, and the service providing capability value 1012. The checksum accordingly does not guarantee the validity of the packet transfer capability value 1013. The network interface unit 13b calculates the checksum as if the packet transfer capability field 1013 were absent.

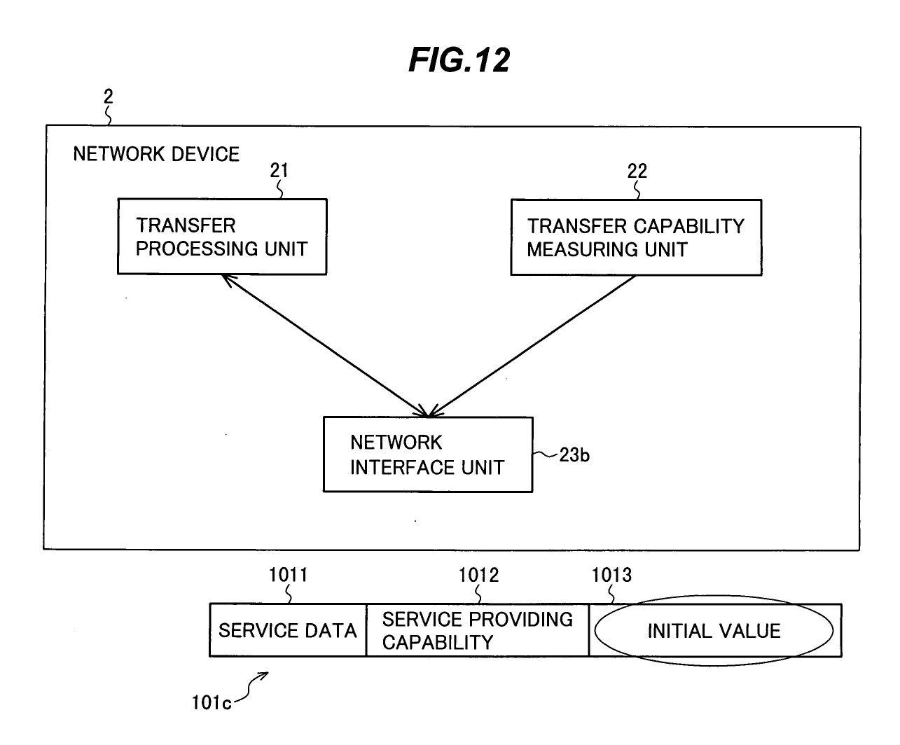

Referring to FIG. 12, the network device 2 in the third embodiment includes at least a transfer processing unit 21, a transfer capability measuring unit 22, and a network interface 23b that are generally similar to the corresponding elements in the first embodiment and are similarly interconnected.

The transfer processing unit 21 and transfer capability measuring unit 22 operate as described in the first embodiment. The network interface 23b also operates as described in the first embodiment, except that it does not recalculate the checksum in the packet header 1015 after updating the packet transfer capability value 1013.

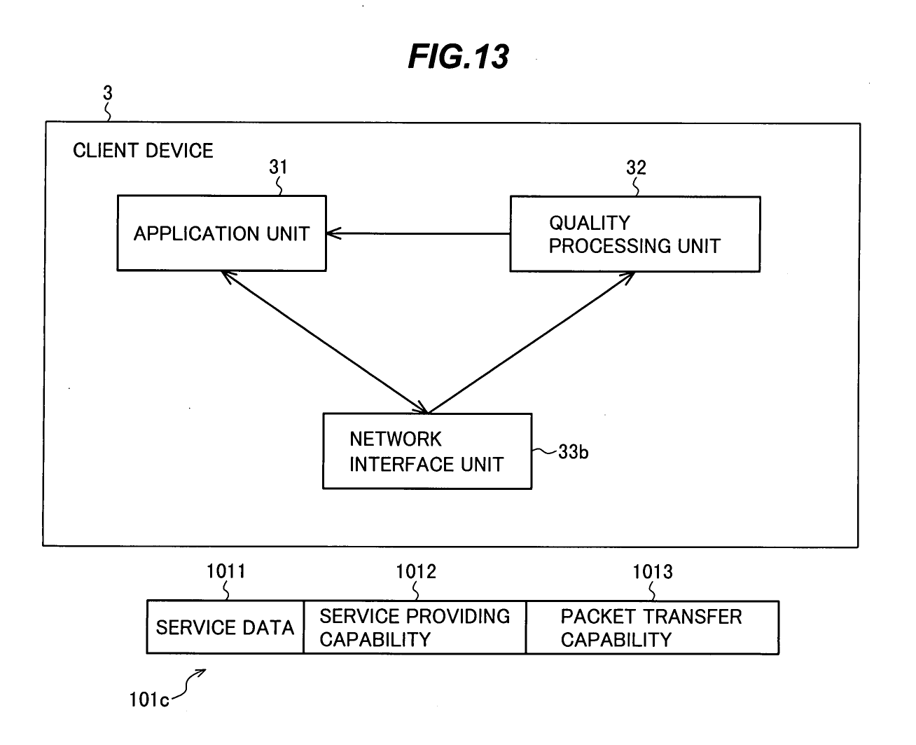

Referring to FIG. 13, the client device 3 in the third embodiment includes at least an application unit 31, a quality processing unit 32, and a network interface unit 33b that are generally similar to the corresponding elements in the first embodiment and are similarly interconnected.

The server 1 and quality processing unit 32 operate as described in the first embodiment. The network interface unit 33b also operates as described in the first embodiment, except that in verifying the checksum value in a received service data packet, it excludes the packet transfer capability field 1013 (if present) from the checksum calculation.

The third embodiment operates in the same way as the first embodiment, except for differences in steps S5, S9, and S10 in FIG. 5.

In step S5, when assembling a data packet 101c by appending the service providing capability field 1012 and packet transfer capability field 1013 to the service data 1011, the network interface unit 13b calculates the checksum on the basis of the packet header 1015, service data 1011, and service providing capability value 1012, excluding the packet transfer capability value 1013.

In step S9, after updating the packet transfer capability value 1013, the network interface 23b does not recalculate the checksum but sends the packet on the next hop of its traffic path with the checksum unaltered.

In step S10, in verifying the checksum of a received data packet 101, the network interface unit 33b excludes the packet transfer capability value 1013 from the checksum calculation.

By excluding the packet transfer capability value 1013 from the checksum calculation, the client device 3 eliminates the need to recalculate and update the checksum at every network device 2 on the traffic path, and shortens the checksum calculation at the server 1 and client device 3 at both ends of the traffic path, thereby reducing the data processing load on all devices involved, and in particular on the network devices 2. This load reduction entails the possibility that the received packet transfer capability value 1013 may be incorrect, but does not compromise the reliability of the other data in the received packet 101c.

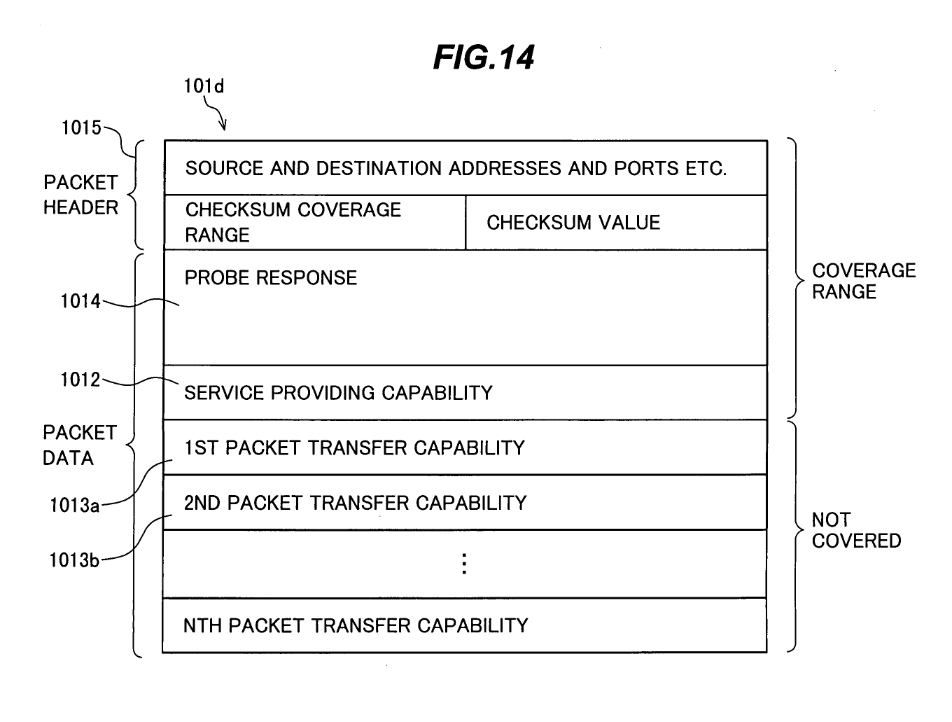

Referring to FIG. 14, in a variation of the third embodiment, data packets 101d including probe responses 1014 sent in reply to a probe packet as in the second embodiment also have a packet header 1015 with a checksum coverage range field, and this checksum coverage range field indicates that the packet transfer capability values 1013a, 1013b, . . . added to the packet 101d as it traverses its traffic path are excluded from the checksum. The checksum is accordingly calculated only from the packet header 1015, the probe response 1014, and the service providing capability value 1012. The effect of reduced processing load is therefore also obtained for probe response packets.

In a further variation of this variation, the packet transfer capability value 1013 of a data packet including a probe response is updated as in the first embodiment. The updated packet transfer capability value 1013 is also excluded from the checksum calculation in this variation.

Conversely, packet transfer capability fields 1013 including identifying information may be appended to service data packets, instead of simply updating a single packet transfer capability value 1013. All of the appended packet transfer capability fields 1013 are excluded from the checksum calculation.

In all of these variations, no checksum calculations are performed at network devices 2 on the traffic path of a packet.

Those skilled in the art will recognize that further variations are possible within the scope of the invention, which is defined in the appended claims.

What is claimed is:

1. A server connected to a communication network, comprising:
a service providing unit that generates payload data; and
a first network interface unit that receives the payload data from the service providing unit, generates a packet including the payload data and at least one of a first capability field and a second capability field, and sends the packet to the communication network to be transmitted on a traffic path toward a destination, the first capability field indicating a capability of the service providing unit to provide the payload data, the second capability field indicating a capability of the traffic path to transfer the packet.

2. The server of claim 1, further comprising a service providing capability measuring unit for measuring at least one of activity of a central processing unit (CPU) of the server, memory usage in the server, occupancy of the CPU by an active application program, amount of memory allocated to the active application program, a disk input/output interrupt rate, and usage of the first network interface unit and thereby determining a value indicating the capability of the service providing unit to provide the payload data, wherein the packet includes the first capability field and the first network interface unit places the value determined by the service providing capability measuring unit in the first capability field.

3. The server of claim 2, wherein the packet has a packet header and the first network interface unit calculates a checksum from at least the packet header, the payload data, and the first capability field and places the checksum in the packet header.

4. A network device connected to the server of claim 2 through the communication network, comprising:
a second network interface unit for receiving the packet sent from the server;
a transfer processing unit for determining a next destination of the packet on the traffic path; and
a transfer capability measuring unit for measuring at least one of a CPU load in the network device, an amount of data currently queued in a queue buffer in the network device, a mean packet transfer time, a packet transfer time variance, a load on the second network interface unit, a packet loss rate, and a packet propagation delay and thereby determining a value indicating a packet transfer capability of the network device; wherein
if the packet, when received, lacks the second capability field, the second network interface unit adds the second capability field to the packet and places a prescribed initial value in the second capability field;
if the packet, when received, already has the second capability field, the second network interface unit updates the second capability field in the packet by subtracting the value determined by the transfer capability measuring unit from the value in the second capability field; and
the second network interface unit sends the packet with the added or updated second capability field to the next destination determined by the transfer processing unit.

5. The network device of claim 4, wherein the second network interface unit sends the packet to the next destination determined by the transfer processing unit without performing a checksum calculation.

6. A network system comprising:
the network device of claim 4; and
a client device connected to the network device through the communication network and functioning as the destination of the packet sent from the server, the client device including:
a third network interface unit for receiving the packet sent from the server;
an application unit for processing the payload data in the received packet, thereby receiving a service; and
a quality processing unit for processing at least the second capability field in the received packet and passing quality information to the application unit responsive to content of the second capability field; wherein
when the quality information received from the quality processing unit indicates that a prescribed quality of service cannot be obtained, the application unit takes action including one of canceling the service and reducing a requested level of the service.

7. A network device connected to the server of claim 2 through the communication network, comprising:
a second network interface unit for receiving the packet sent from the server;
a transfer processing unit for determining a next destination of the packet on the traffic path; and
a transfer capability measuring unit for measuring at least one of a CPU load in the network device, an amount of data currently queued in a queue buffer in the network device, a mean packet transfer time, a packet transfer time variance, a load on the second network interface unit, a packet loss rate, and a packet propagation delay and thereby determining a value indicating a packet transfer capability of the network device; wherein
the second network interface unit appends a new second capability field to the packet, places the value determined by the transfer capability measuring unit in the new second capability field, adds identifying information identifying the network device to the new second capability field, and sends the packet with the new second capability field to the next destination determined by the transfer processing unit.

8. The network device of claim 7, wherein the network interface unit sends the packet to the next destination determined by the transfer processing unit without performing a checksum calculation.

9. A client device connected to the network device of claim 7 through the communication network, comprising:
a network interface unit for receiving the packet sent from the server;
an application unit for processing the payload data in the received packet, thereby receiving a service; and
a quality processing unit for processing at least the new second capability field in the received packet and passing quality information to the application unit, the quality information including at least the value and identifying information placed in the new second capability field; wherein
when the quality information received from the quality processing unit indicates that a prescribed quality of service cannot be obtained, the application unit uses the value and identifying information in the new second capability field to determine whether the network device that added the new second capability field is responsible for failure to obtain the prescribed quality of service.

10. A network system comprising:
the network device of claim 7; and
a client device connected to the network device through the communication network and functioning as the destination of the packet sent from the server, the client device including:
a third network interface unit for receiving the packet sent from the server,
an application unit for processing the payload data in the received packet, thereby receiving a service, and
a quality processing unit for processing at least the new second capability field in the received packet and passing quality information to the application unit, the quality information including at least the value and identifying information placed in the new second capability field; wherein
when the quality information received from the quality processing unit indicates that a prescribed quality of service cannot be obtained, the application unit uses the value and identifying information in the new second capability field to determine whether the network device that added the new second capability field is responsible for failure to obtain the prescribed quality of service.

11. The server of claim 1, wherein the packet includes the second capability field and the first network interface unit places a prescribed initial value in the second capability field.

12. The server of claim 11, wherein the packet has a packet header and the first network interface unit calculates a checksum from at least the packet header and the service data, excluding the second capability field, and places the checksum in the packet header.

13. A network device connected to the server of claim 11 through the communication network, comprising:
a second network interface unit for receiving the packet sent from the server;
a transfer processing unit for determining a next destination of the packet on the traffic path; and
a transfer capability measuring unit for measuring at least one of a CPU load in the network device, an amount of data currently queued in a queue buffer in the network device, a mean packet transfer time, a packet transfer time variance, a load on the second network interface unit, a packet loss rate, and a packet propagation delay and thereby determining a value indicating a packet transfer capability of the network device; wherein
the second network interface unit updates the second capability field in the packet by subtracting the value determined by the transfer capability measuring unit from the value in the second capability field, and sends the packet with the updated second capability field to the next destination determined by the transfer processing unit.

14. The network device of claim 13, wherein the second network interface unit sends the packet to the next destination determined by the transfer processing unit without performing a checksum calculation.

15. A network system comprising:
the network device of claim 13; and
a client device connected to the network device through the communication network and functioning as the destination of the packet sent from the server, the client device including
a third network interface unit for receiving the packet sent from the server,
an application unit for processing the payload data in the received packet, thereby receiving a service, and
a quality processing unit for processing at least the second capability field in the received packet and passing quality information to the application unit responsive to content of the second capability field; wherein
when the quality information received from the quality processing unit indicates that a prescribed quality of service cannot be obtained, the application unit takes action including one of canceling the service and reducing a requested level of the service.

16. The server of claim 1, wherein the payload data provides a service to a device connected to the communication network.

17. The server of claim 1, wherein the server generates the payload data in response to a probe packet received from a device connected to the communication network, the probe packet including a request for communication quality information.

18. A client device connected to the server of claim 1 through the communication network, comprising:
a third network interface unit for receiving the packet sent from the server;
an application unit for processing the payload data in the received packet, thereby receiving a service; and
a quality processing unit for processing the at least one of the first capability field and the second capability field in the received packet and passing quality information to the application unit responsive to content of the at least one of the first capability field and the second capability field; wherein
when the quality information received from the quality processing unit indicates that a prescribed quality of service cannot be obtained, the application unit takes action including one of canceling the service and reducing a requested level of the service.

19. A network system comprising:
the server of claim 1; and
a client device connected to the network device through the communication network and functioning as the destination of the packet sent from the server, the client device including
a third network interface unit for receiving the packet sent from the server,
an application unit for processing the payload data in the received packet, thereby receiving a service, and
a quality processing unit for processing the at least one of the first capability field and the second capability field in the received packet and passing quality information to the application unit responsive to content of the at least one of the first capability field and the second capability field; wherein
when the quality information received from the quality processing unit indicates that a prescribed quality of service cannot be obtained, the application unit takes action including one of canceling the service and reducing a requested level of the service.

20. The network system of claim 19, further comprising a network device connected to the server through the communication network, for transferring the packet sent from the server, the network device including:
a transfer processing unit for determining a next destination of the packet on the traffic path;
a transfer capability measuring unit for measuring at least one of a CPU load in the network device, an amount of data currently queued in a queue buffer in the network device, a mean packet transfer time, a packet transfer time variance, a load on the second network interface unit, a packet loss rate, and a packet propagation delay and thereby determining a value indicating a packet transfer capability of the network device; and
a second network interface unit for using the value determined by the transfer capability measuring unit to update the second capability field in the packet sent from the server or add a new second capability field to the packet sent from the server, and transferring the packet with the new or updated second capability field to the next destination determined by the transfer processing unit.
